(19) United States
(12) Patent Application Publication
(10) Pub. No.: US 2011/0101198 A1
(43) Pub. Date: May 5, 2011

(54) "L" SHAPED SUPPORT DEVICE FOR A HOISTING MACHINE IN A MACHINE ROOMLESS ELEVATOR

(75) Inventor: Yuriy Trach, Thornhill (CA)

(73) Assignee: ThyssenKrupp Northern Elevator Corporation

(21) Appl. No.: 12/609,540

(22) Filed: Oct. 30, 2009

(51) Int. Cl. F16M 13/02; B66B 7/00; B66B 11/04

(52) U.S. Cl. 248/674

(57) ABSTRACT

According to a primary aspect of the invention there is provided a support for an elevator hoisting machine. Whenever “elevator hoisting machine” is referred to in the present disclosure synonomous equipment such as drives, winches, or the like also apply. The above-mentioned support is intended for use in an elevator including a counterweight with the ends of the hoist ropes being fixed in the overhead of the hoistway. The mounting plate for the hoisting machine contained within the support is attached to the bottom of a vertically oriented structural plate which forms the substantially “L” shaped support. The vertically oriented structural plate therefore spans the elevator hoistway from the front wall to the rear wall with the ends of the said plate resting in pockets provided in the front and rear walls of the hoistway by being attached to these pockets using horizontal bearing angles.

### FIELD OF THE INVENTION

This invention relates to the supporting of a drive for an elevator and specifically a device used for the support for an elevator hoisting machine.

### BACKGROUND OF THE INVENTION

Heretofore it is known to provide an elevator hoistway within which a passenger car travels and providing a hoisting machine for that elevator car in the hoistway but without the need for providing a room at the top end of the hoistway above the limit of the travel of the car. Most manufacturers therefore have their own version of a machine roomless construction which varies from manufacturer to manufacturer in order to carry out their best efficiencies and at the same time having respect to other manufacturer's constructions.

Examples of the prior art described herein clearly show that such a roomless construction is not unique. For example, U.S. Pat. No. 6,488,124 assigned to Toshiba teaches many variations of such a construction as best in the Figures including an elevator car and a counterweight construction both moving on separate rails and including a hoisting device offset from the center axis of the hoistway which does not require a machine room for that hoisting device. As best seen in FIG. 2 that hoisting machine is mounted on the wall of the hoistway in order to accomplish this roomless construction. Other ways are also taught in the patent and specifically most relevant to the present invention there is as shown in FIG. 41 a substantially “L” shaped bracket or right-angled bracket that has a reinforcement portion to the bracket 318 with the vertical leg being secured to the reinforced wall through inserts and bolts 317. The drive is substantially cigar shaped. A further embodiment of this construction is also shown in FIG. 44. Referring now to column 20, line 51 of the description, this so called 19th embodiment of the present invention of the '124 patent is described that any loads acting on the device of FIG. 41 is entirely supported by the elevator shaft wall. FIG. 44 further improves the construction of FIG. 41 with the provision of elastic member 320 as shown in the drawing.

However, even though there is a similarity in the “L” shaped bracket construction of FIG. 41 the construction is inverted to the present invention which is described heretofore. The member 318 would severely limit the travel of a counterweight separate from the passenger car. It therefore creates an unnecessary problem providing such a construction taking into account the invention of the present Applicant. Applicant therefore has obviated this problem by the construction as follows herein.

U.S. Pat. No. 7,025,177 to L.G. Industrial Systems also teaches an elevator system without a machine room characterized by the fact that the stroke of the counterweight is shorter than the overall stroke of the elevator car.

Referring now to U.S. Pat. No. 7,108,105 to Spacelift S.R.L. there is taught a single compartment or shaft for housing a moveable cage as best seen in FIG. 1 which describes how the inventor of the '105 patent obviates the construction of a machine room.

Referring now to U.S. Pat. No. 7,383,924 to Toshiba there is taught a machine roomless elevator construction which includes rubber vibration isolators to reduce vibration generated by the driving device within the elevator construction.

Referring now to U.S. Pat. No. 7,428,950 to Otis Elevator there is taught a low overhead machine roomless elevator configuration which includes a cantilevered car substantially as shown in FIG. 1, in effect offsetting the travel of the passenger car from any cables or counterweights.

Many other examples in the art are also available but the above-mentioned examples were just selected with respect to being relevant to machine roomless constructions.

The Assignee of this patent application also currently sells a product as best seen in FIG. 7 labeled as prior art to address the need for a machine roomless construction. Clearly as seen in FIG. 7 the drive D is mounted on beams R1 and R2 at the upper extremity of the hoistway and the beams traverse substantially the entire hoistway from front to back and are connected with horizontal bearing angles B within the openings provided in pockets contained within the wall of the hoistway. However, in spite of the many advantages of that embodiment shown in FIG. 7 the overhead requirement is still more than many purchasers want in their system and therefore a need exists to offer to the market place a construction that provides less space requirement in the overhead of an elevator hoistway.

It is therefore a primary object of the invention to provide a support device for a hoisting machine in a machine roomless elevator construction which further reduces the height requirement that an elevator hoistway requires in a building.

It is a further object of this invention to provide a substantially “L” shaped machine support for the drive of an elevator also known as an elevator hoisting machine.

It is yet a further object of the invention to provide the bracket construction as a substantially “L” shaped machine support which is designed so as not to interfere with the motion of the counterweights in the hoistway.

It is yet a further object of the invention to provide the construction of a support for an elevator hoisting machine which may be bolted together in a simple manner at the construction site.

Further an other objects of the invention will become apparent to one skilled in the art when considering the following summary of the invention and the more detailed description of the preferred embodiments illustrated herein.

### SUMMARY OF THE INVENTION

According to one aspect of the invention there is provided a support for an elevator hoisting machine. Whenever “elevator hoisting machine” is referred to in the present disclosure synonomous equipment such as drives, winches, or the like also apply. The above-mentioned support is intended for use in an elevator including a counterweight with the ends of the hoist ropes being fixed in the overhead of the hoistway. The mounting plate for the hoisting machine contained within the support is attached to the bottom of a vertically oriented structural plate which forms the substantially “L” shaped support. The vertically oriented structural plate therefore spans the elevator hoistway from the front wall to the rear wall with the ends of the said plate resting in pockets provided in the front and rear walls of the hoistway by being attached to these pockets using horizontal bearing angles.

By providing such a construction the generally “L” shaped machine support will reduce the overhead requirement since the beam supports required for supporting the hoisting machine in known constructions as described herein in relation to FIG. 7 are no longer required thereby depending on elevator capacity, reducing the overall hoistway overhead height by the height of common machine beams which typically are 8″ (203 mm) high or taller. The present construction will not obstruct the space above the elevator car and eliminates the creation of a safety hazard for elevator service personnel should the car lurch at any particular point in time. A further potential of reduction of a further vertical space is therefore available as well yet providing excellent access to the elevator hoisting machine/drive to service and maintenance personnel while meeting the elevator safety code, not interfering with other elevator equipment in the overhead, by providing a cost effective construction, and which can be assembled on site from the parts provided in a transported package. One might consider this package a kit.

According to yet another aspect of the invention there is provided a substantially “L” shaped support bracket for a passenger elevator drive assembly comprising a substantially flat planer member oriented vertically with respect to an elevator hoistway, said member comprising a top and a bottom and two sides and having disposed proximate the bottom thereof a horizontally extending flat planer member engaged with said vertical member, said horizontal planer member carrying the drive assembly for said elevator car, said vertically oriented member being supported by horizontal bearing angles engaged with the cutouts of the elevator hoisting shaft wherein said “L” shaped support bracket allows for a machine roomless construction for an elevator assembly provided and results in less requirement for overhead in the hoistway.

According therefore to a primary aspect of the invention and yet another embodiment there is provided a support device for an elevator hoisting machine to be positioned between the walls in an elevator hoistway, said device comprising a flat vertical member extending substantially the entire dimension of the hoistway from the front wall to the back wall and being supported proximate the bottom thereof in pockets disposed within the front and rear wall of the hoistway and being supported thereat by horizontal bearing angles provided and disposed within the pocket of the hoistway walls. Said support device also including a flat planer platform substantially perpendicular to the vertical member and attached proximate the bottom thereof and extending from one side thereof. Preferably structural braces are provided to interconnect the flat platform with the vertical member.

In one embodiment of the invention said “L” shaped bracket further comprises a vertically oriented flat planer member that substantially spans the elevator hoistway. Preferably said plate is gusseted at its ends for stability.

Preferably the ends of said vertically oriented member engages pockets disposed within the front and rear walls of the hoistway.

### BRIEF DESCRIPTION OF THE DRAWINGS

FIG. 1 is a schematic perspective view of the equipment installed within a hoistway for an elevator assembly incorporating the machine frame 10 for the present invention illustrating generally the parts of the entire elevator assembly illustrated in a preferred embodiment of the invention.

FIG. 2 is a schematic view of the machine support 10 showing essentially how the entire assembly is integrated so that a minimum of overhead is required in the hoistway.

FIG. 3 is a schematic view of the present invention illustrated in a preferred embodiment itemizing the various components thereof.

FIGS. 4A and 4B are perspective views from the rear of the machine support assembly 10 showing how the entire assembly would be assembled in a hoistway and illustrated in a preferred embodiment of the invention.

FIG. 5 is a similar view to that of FIG. 4B with the exception that the hitch plate is for the position of the counterweight to one side of the machine support assembly whereas in FIG. 4B it is disposed on the other side of the assembly and shown in a preferred embodiment of the invention.

FIGS. 6A, 6B and 6C are rear, top and bottom views of the machine support 10 illustrated in a preferred embodiment of the invention.

FIG. 7 is a perspective view of a prior art device manufactured by the Assignee of the present patent application and is considered as prior art.

FIG. 8 is a further view illustrating the prior construction of a machine roomless installation focusing on the top of the hoistway with a product that has been marketed by the Assignee for a number of years and is considered prior art to the present invention.

### DETAILED DESCRIPTION OF THE PREFERRED EMBODIMENTS

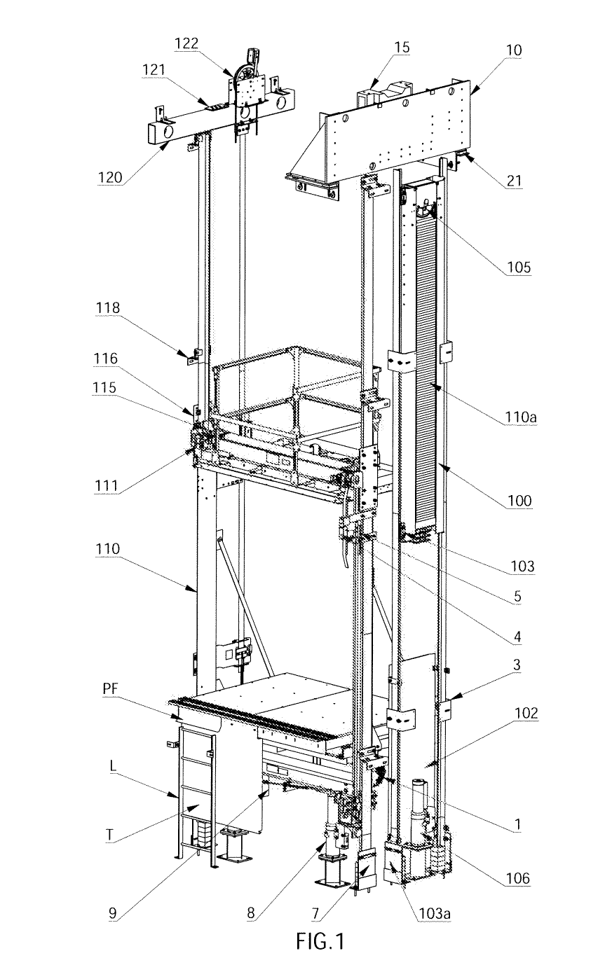

The following table itemizes the components of FIG. 1 for the elevator assembly which are not part of the present invention. These components are well known in the art.

| # | Description | # | Description |
|---|---|---|---|
| 122 | Governor | 7 | Car rail support |
| 121 | End hitch plate | 105 | CWT idler sheave |
| 120 | Beam, End hitch | 110a | CWT blocks |
| 118 | Car rail bracket | 100 | CWT frame |
| 116 | Car safety plate | 103 | CWT guide shoes |
| 115 | Car roller guide | 5 | Magnet switch & activator |
| 111 | Car safety lock | 4 | Limit switch & cam |
| 110 | Stile | 3 | CWT rail bracket |
| PF | Pit fascia | 102 | CWT guard |
| L | Pit ladder | 1 | Idler sheaves |
| T | Toe guard | 106 | CWT buffer |
| 9 | Governor idler | 103a | CWT rail support |
| 8 | Car buffers | | |

In order to clarify the drawings, the list of the parts with the corresponding reference numbers are provided below with respect to the present invention:

| # | Description | # | Description |
|---|---|---|---|
| 10 | Machine frame | 26a | Strap member link |
| 15 | Machine (hoist) | 26b | Strap member link |
| 17a | Sheave | 26(i) | Strap member |
| 17 | Sheave cover | 27 | Gusseted mounting bracket |
| 20 | Vertical plate | 27a | Wing |
| 21 | Isolation pads | 27(i) | “L” shaped leg |
| 23 | End hitch plates | 28 | Left support bracket |
| 25 | Horizontal support | 29 | Right support bracket |
| 25a | Linking bracket | B | Masonry block |
| 25b | Linking bracket | I | Support I-beam |
| 25c | Linking bracket | Bt | Attachment bolts |
| 25(i) | Cable passageway | R | Rubber pads (see item 21) |
| 26 | Strap member | X | Height saved |

When discussing the details of the preferred embodiment herein and with respect to the numbering of the various parts thereof like parts have been numbered to be consistent with the same part in this disclosure. However, in spite of the care that was taken to label the figures it is potentially possible that not all the labeled items are labeled in each and every figure. Therefore the labeling is implied to be consistent from figure to figure so that like parts are described with like numbers.

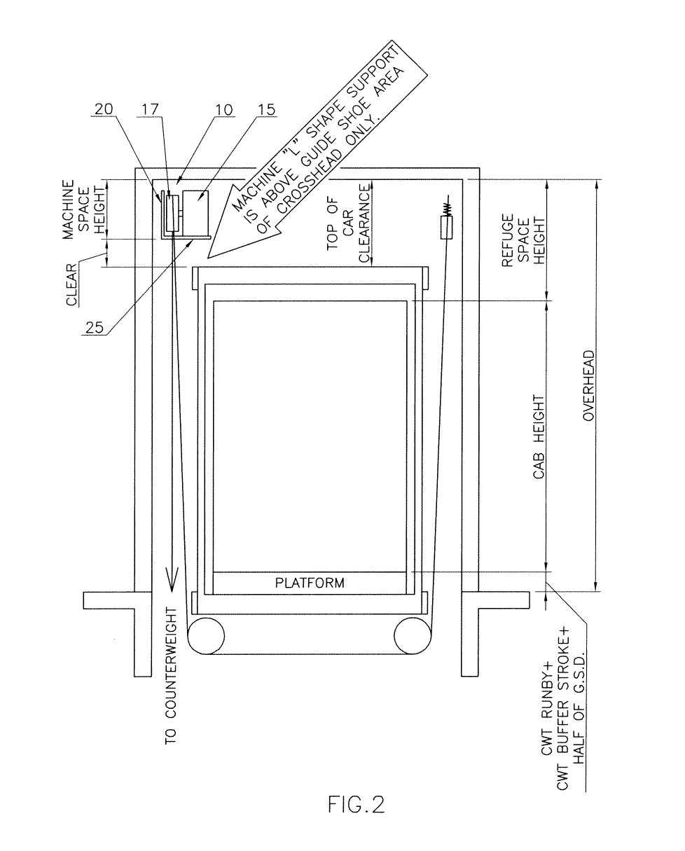

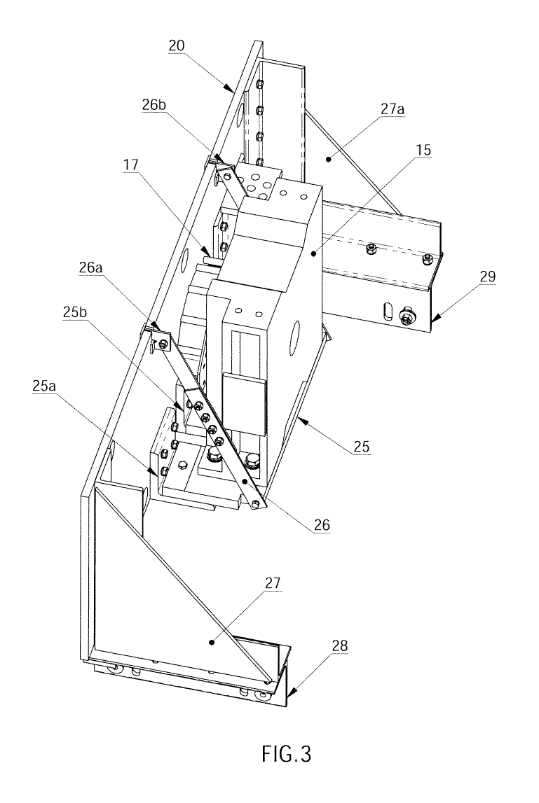

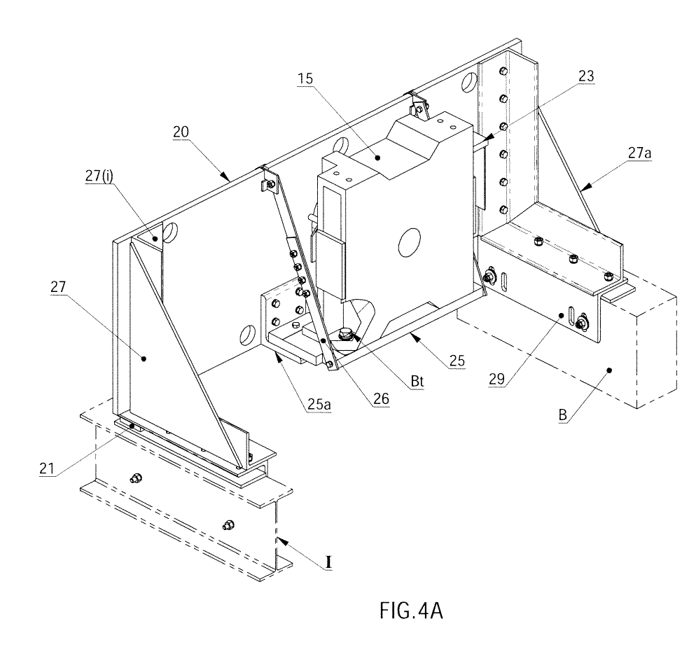

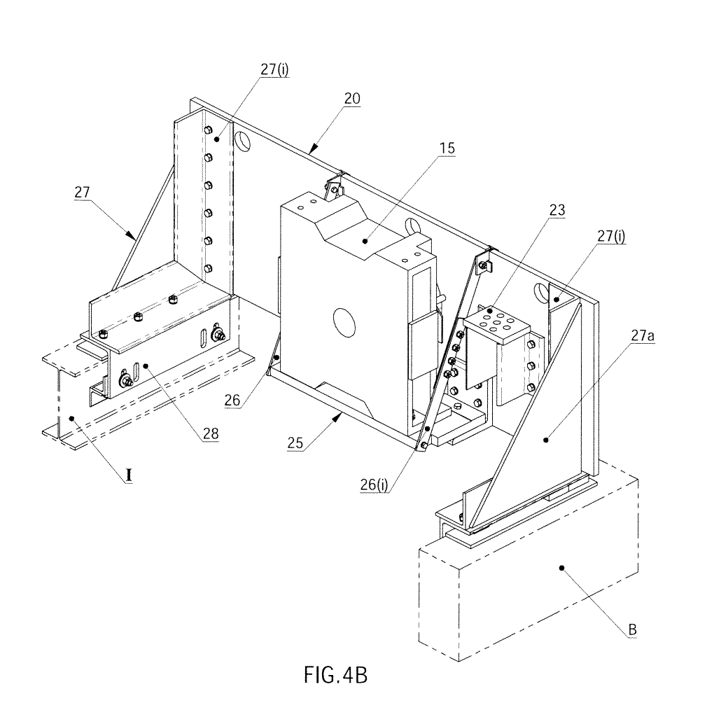

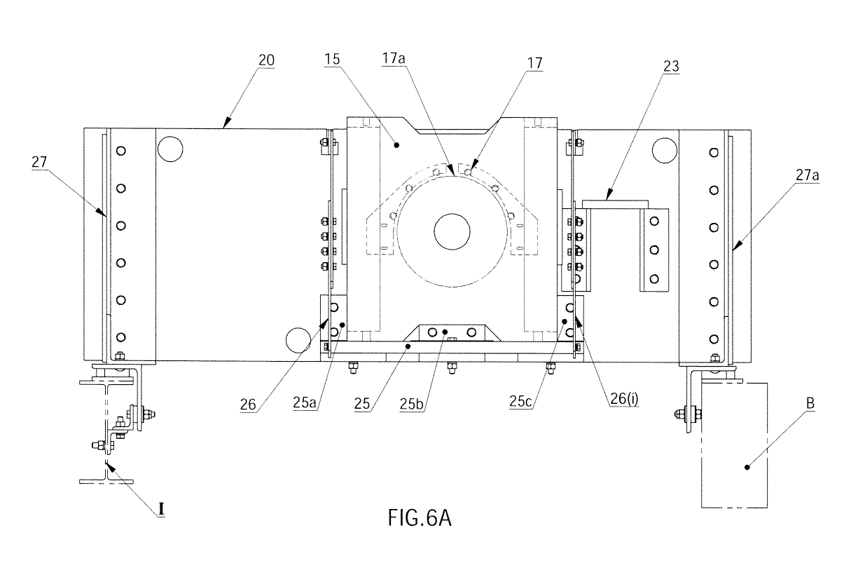

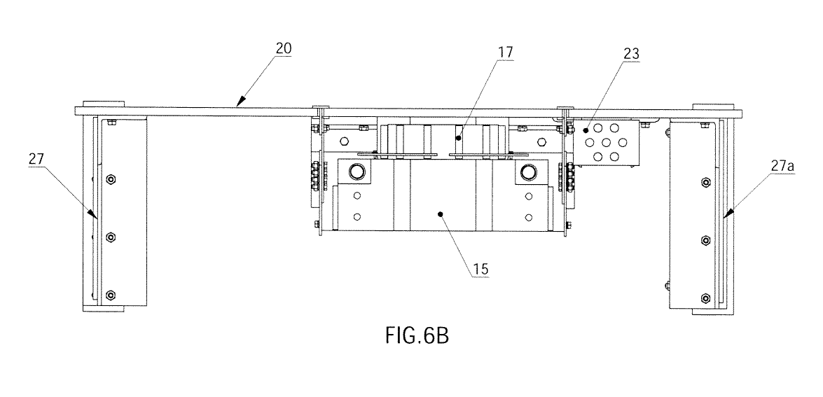

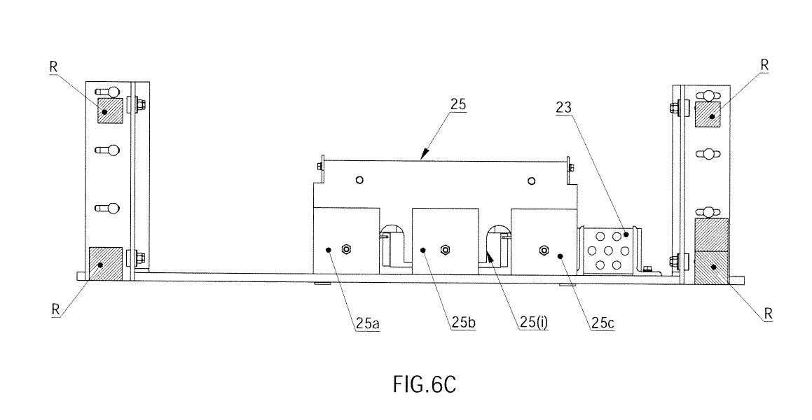

Referring therefore to the Figures there is illustrated a machine frame 10 to support a machine 15 or alternatively referred to as a hoist or drive motor and in that sense these terms should be considered equivalent throughout this disclosure. The machine 15 is a flat pancake design and is best seen in relation to FIG. 3 and is generally a purchased item and is not considered to be part of the invention outside of the aspect of there being a drive or a machine or hoist that is utilized to move the elevator car from the top to the bottom of the hoistway. The machine is therefore supported by a horizontal supporting member or platform 25 that extends from a vertical plate 20 which is essentially the load bearing member of this system. As is best seen in relation to FIG. 2 the vertical and horizontal plates carry the hoist or machine at the top side of the hoistway so as to provide the maximum space in the overhead in the hoistway for access to service personnel without requiring a machine room. This provision provides for reduction in the overall height of a hoistway and therefore in the overall height of the building potentially as seen in FIG. 2 the platform or support assembly 10 only requires a predetermined space height and provides for an advantage over the prior construction and even that of the present Assignee of at least a minimum of 8″ (203 mm) reduction in the head space and potentially further vertical space which will be described hereinafter. The horizontal platform 25 or support is attached to the vertical support member 20 via link members 25a, 25b and 25c and 26a and 26b which are bolted in place and positioned so that a strap member 26 is provided to add further reinforcement to the mounting of the horizontal member 25 to the vertical plate 20. Opening 25(i) which is best seen in relation to FIG. 6C a space therefore is provided between the supporting linking brackets 25a, 25b and 25c to allow passage of the cable which passes around the sheave 17a of the machine 15. The vertically redisposed plate 20 is supported proximate the ends thereof in either a masonry block or an I-beam provided within the pockets in the hoistway with the vertical member 20 spanning the hoistway as best seen in FIG. 4A. The vertical plate 20 is therefore reinforced proximate the ends thereof as best seen in FIG. 4A with respect to channel portions which are gusseted generally labeled as 27 which includes vertical and horizontal legs which are bolted in place to supplementary brackets which essentially engage the masonry block B or the I-beam I. This joint is also isolated from vibration using rubber pads R which is also not part of the invention. As best seen in the Figures there are a number of cut outs and bolt openings and bolts and nuts needed to provide the assembly of the entire machine support which is shipped as a kit of components predrilled with all of the materials required to complete the assembly. The kit therefore would include all of the bits and parts indicated herein and is considered to be part of the invention, that is that one can have the various components manufactured in different metal machine shops and shipped to the site for the entire kit to be assembled on site. The bolting of the brackets in position at all times is preferred to other methods of fastening as being a more positive joint available to the manufacturer. However, many installers prefer the whole machine support frame to be bolted together at the factory so it can be lifted with a crane via the lifting holes provided at the top of vertical plate 20 and subsequently dropped into the pockets while the building roof is still not finished. It is well known to provide pockets within the top area of a hoistway which may contain I-beams or blocks or both which can be accessed in order to secure the machine support 10. All of the plates including the horizontal plate and the vertical plate and the various linking brackets such as linking bracket 25a are all made of mild steel of a predetermined grade and thickness so as to enable the support of a load up to and an excess of safety code requirements. The selection of the bolts is consistent again with the safety code to provide shear failure well above any overall constraints of the safety code. Those skilled in the art would know these various code requirements.

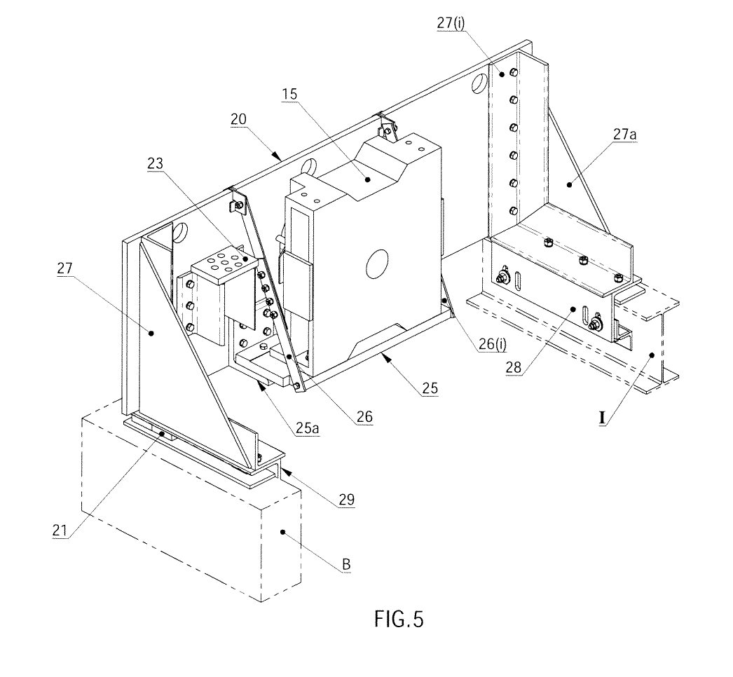

Referring to FIG. 4B as an example the various vertical and horizontal legs, the gusseted bracket 27 is shown with the vertical leg 27(i), 27a and 27(ii) shown, which provides reinforcement in three dimensions for the fixing of the horizontal plate 20 to the brick masonry B or the I-beam I of the hoistway pockets. The forces therefore available are transmitted through these brackets 27 which include the wing portion 27a on each end thereof to ensure that any forces on the plates are passed on to a structural member of the hoistway. The end hitch plate 23 is as shown in FIGS. 4A and 4B as well as in FIG. 5 which shows an alternative positioning of the hitch plate when the counterweight is at one side or the other of the hoistway.

Referring now to FIGS. 6A, 6B and 6C there is shown a side view, top view and bottom view of the machine support assembly in order to illustrate the details of the various components and how the machine sheave 17a is positioned with respect to the machine 15 with sheave cover 17 shown in the position in FIG. 6A. Also the details of the bracket 25c which is the bottom bracket for mounting the horizontal plate 25 onto the vertical plate 20 proximate the bottom thereof with all of the linking brackets 25a, 25b and 25c and the bolting thereof in position is best seen in relation to FIG. 5 illustrating clearly a cut away of the bottom of the machine and how it is mounted in position on the horizontal plate 25 but not shown. It is submitted this is done at the four corners so that the machine is positioned securely at all times and safety is never compromised. Rubber portions R are best seen in FIG. 6C as well as FIG. 1. These pads are in fact the isolation pads 21 but they are also utilized in the prior art and therefore are not considered part of the invention.

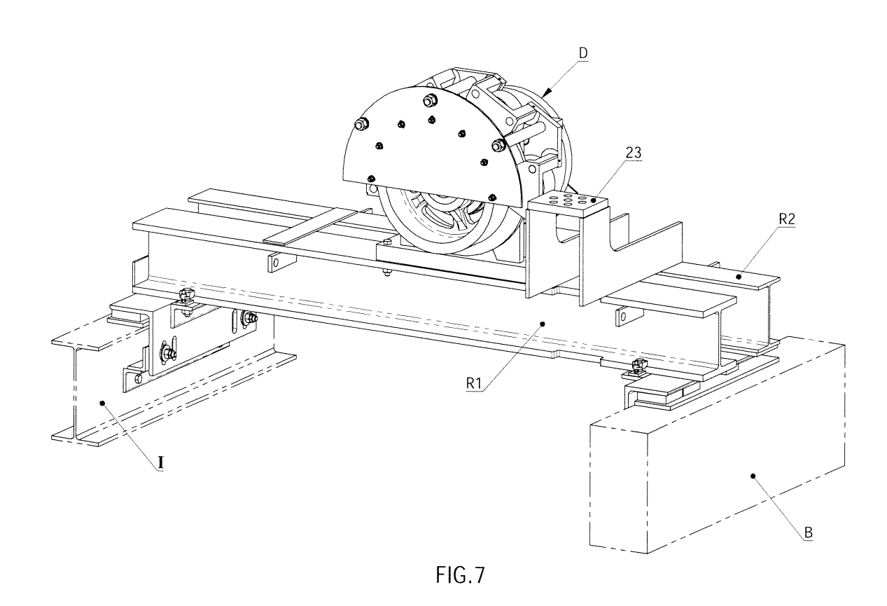

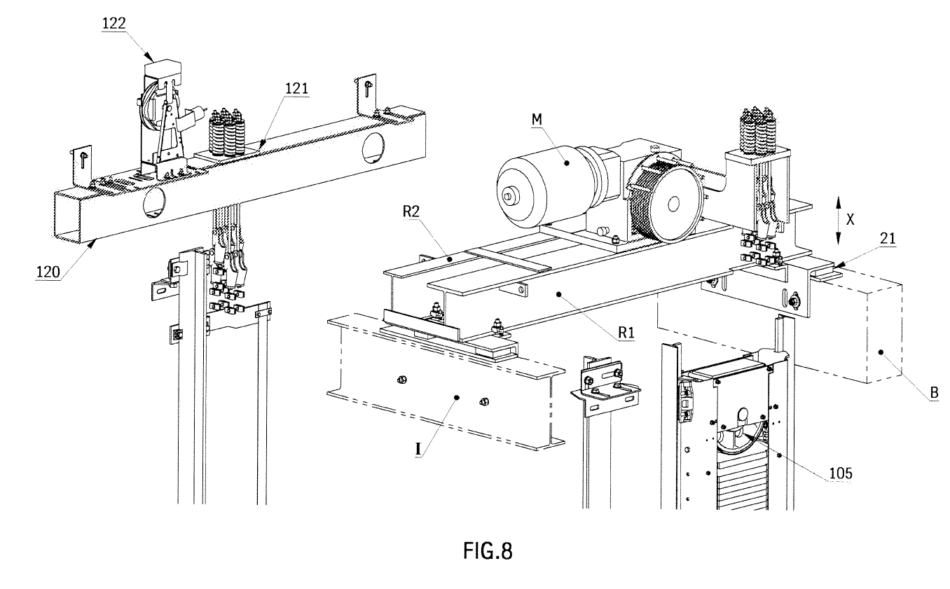

Referring now to FIGS. 7 and 8 these figures illustrate prior art constructions of the present Assignee which was installed in a hoistway to reduce the overall head room requirements of the hoistway when utilizing various drive motors M or D depending on the selection of the drive and the positioning of the sheave. Rail portions R1 and R2 were used to support the machine of the prior art in position with the various brackets as illustrated, on the I-beam I and brick masonry B as shown. Therefore the girth X of the rails is eliminated and may be considered part of the advantageous of the current assembly.

Further and other changes may be made to the preferred embodiments of the invention without departing from the scope thereof. It is considered a part of this invention to reflect a certain variation in the components and structure in other embodiments of the invention. For example, it is not intended to unnecessarily limit the construction of the machine support to support only a flat pancake motor but other motor styles can be also installed. The simplest use would be that of a pancake motor and other drives known in the art.

Therefore as many changes can be made to the preferred embodiments without departing from the scope thereof. It is considered that the summary of the invention and the figures contained herein be considered illustrative of the invention and not in a limiting sense.

The embodiments of the invention in which an exclusive property or privilege is claimed are as follows:

1. A support for an elevator hoisting machine for use in an elevator including a counterweight with the ends of hoist ropes being fixed in the overhead of the hoistway, said support comprising a mounting plate for the hoisting machine attached to the bottom of a vertically oriented structural plate which forms with said mounting plate a substantially “L” shaped support for the hoisting machine, the vertically oriented structural plate therefore spanning the elevator hoistway from the front wall to the rear wall with the ends of the said plate connecting with pockets provided in the front and rear walls of the hoistway and being attached to these pockets using bearing angles.

2. The support of claim 1 reducing the overhead requirements thereof in comparison to known supports for an elevator hoistway since the beam supports required for supporting the hoisting machine in known constructions are no longer required thereby reducing the overall hoistway overhead height by the height of common machine beams.

3. The support of claim 1 provided as a kit of components which can be assembled on site from the parts provided in the kit.

4. The kit of claim 3 provided as an unassembled number of parts including the vertical strucural plate, the mounting plate, and the necessary brackets and fasteners needed to assemble the support onsite.

5. A support device for an elevator hoisting machine to be positioned between the walls of an elevator hoistway, said device comprising a flat vertical member extending substantially the entire dimension of the hoistway from the front wall to the back wall and being supported proximate the bottom thereof in pockets disposed within the front and rear wall of the hoistway and being supported thereat by horizontal bearing angles provided and disposed within the pocket of the hoistway walls, said support device also including a flat planer platform substantially perpendicular to the vertical member and attached proximate the bottom thereof and extending from one side thereof.

6. The support device for an elevator hoising machine of claim 5 further comprising structural braces provided to interconnect the flat platform with the vertical member.

7. A substantially “L” support bracket for a passenger elevator drive assembly comprising a substantially flat planer member oriented vertically with respect to an elevator hoistway, said member comprising a top and a bottom and two sides and having disposed proximate the bottom thereof a horizontally extending flat planer member engaged with said vertical member, said horizontal planer member carrying the drive assembly for said elevator car, said vertically oriented member being supported by horizontal bearing angles engaged with the cutouts of the elevator hoisting shaft, wherein said “L” shaped support bracket allows for a machine roomless construction for an elevator assembly and results in less requirement for overhead in the hoistway.

8. The support device for an elevator hoising machine of claim 7 further comprising structural braces provided to interconnect the flat platform with the vertical member.

9. The “L” shaped bracket of claim 7 further comprising a vertically oriented flat planer member that substantially spans the elevator hoistway and engages pockets disposed within the front and rear walls of the hoistway.

10. The “L” shaped bracket of claim 7 wherein said vertically oriented member is gusseted at its ends for stability.
